(19) United States
(12) Patent Application Publication
(10) Pub. No.: US 2010/0047921 A1
(43) Pub. Date: Feb. 25, 2010

(54) METHOD FOR ISOLATION OF BIOPOLYMER BY USING RE-CIRCULATING CHROMATOGRAPHY

(75) Inventors: Tsutomu Suzuki, Tokyo (JP); Kenjyo Miyauchi, Tokyo (JP)

Correspondence Address: GREENBLUM & BERNSTEIN, P.L.C., 1950 ROLAND CLARKE PLACE, RESTON, VA, 20191, US

(73) Assignee: THE UNIVERSITY OF TOKYO, Tokyo (JP)

(21) Appl. No.: 11/997,467

(22) PCT Filed: Aug. 2, 2006
(86) PCT No.: PCT/JP2006/315271

§ 371 Date: Sep. 8, 2009

(30) Foreign Application Priority Data
Aug. 3, 2005 (JP) 2005-224992

(51) Int. Cl. G01N 1/28; B01L 99/00

(52) U.S. Cl. 436/178; 422/101

(57) ABSTRACT

It is an object of the present invention to provide a method for isolating biopolymers, which is capable of simultaneously isolating many types of biopolymers from a single biological sample under the same conditions. The present invention provides a method for isolating biopolymers, which comprises repeating at least twice a process consisting of: (1) a step of preparing at least two vessels each containing a carrier retaining a substance having an affinity for a target biopolymer; then simultaneously introducing a single sample solution containing the target biopolymer into at least the two vessels, and then allowing said sample solution to come into contact with said carrier, so that the target biopolymer can be adsorbed on said carrier; (2) a step of discharging said sample solution from said vessels; and (3) a step of stirring the discharged sample solution.

### TECHNICAL FIELD

The present invention relates to a method for isolating a biopolymer using a reciprocal circulating chromatography.

### BACKGROUND ART

A large number of biopolymers such as DNA, RNA or proteins exist in cells, and such biopolymers play various roles for maintaining life activities. A complicated life phenomenon is generated as a result of the interaction or information exchange among such biopolymers. The human genome analysis has been completed, and the total number of genes encoding proteins was estimated to be approximately 22,000. This number was significantly below the previously estimated number that had been between 30,000 and 35,000, and thus there was really not much difference from the gene number of a fruit fly (20,000). In addition, as another achievement of such human genome analysis, a large amount of transcription product was discovered from non-coding regions that do not encode proteins and make up 98% of the human genome. As a matter of fact, it was revealed that RNA is transcribed from ⅔ of such non-coding regions (Cawley S, Bekiranov S, Ng H H, Kapranov P, Sekinger E A, Kampa D, Piccolboni A, Sementchenko V, Cheng J, Williams A J, Wheeler R, Wong B, Drenkow J, Yamanaka M, Patel S, Brubaker S, Tammana H, Helt G, Struhl K, Gingeras T R. Cell. 2004 Feb. 20; 116 (4): 499-509). In the recent studies, it has being revealed that such non-coding RNA (ncRNA) exists without being translated into a protein, and that it acts as functional RNA. There is a clear correlation between the complexity of the life and an increase in non-coding regions existing in the genome (Taft, R. J. and Mattick, J. S. (2003) [online] http://arXiv.org/abs/q-bio/0401020), and it has been pointed out that such ncRNA may be involved in the source of a complicated life phenomenon. MicroRNA (miRNA) is functional RNA whose analysis has been most advanced among such ncRNAs. The miRNA has become a focus of attention as an important molecule, which complementarily binds to the 3′-end untranslated region of specific mRNA, which induces suppression of the translation of mRNA and decomposition due to RNA interference (RNAi), and which determines the timing of generation and the direction of differentiation (He L, and Hannon G J. MicroRNAs: small RNAs with a big role in gene regulation. Nat Rev Genet. 2004 July; 5(7): 522-31.). Moreover, it has also being revealed that the ncRNA existing in a nucleus induces methylation of DNA or chromatin modification, and that the ncRNA plays an important role in regulation of epigenetic gene expression (Matzke M A, and Birchler J A. RNAi-mediated pathways in the nucleus. Nat Rev Genet. 2005 January; 6(1): 24-35.). Thus, it has been clarified that the ncRNA is actively associated with not only translation regulation in gene expression, but also regulation at a transcription level. A classical central dogma, such as DNA→RNA→a protein, has being drastically broken. Unknown functional RNAs exist among large quantities of ncRNAs. In order to understand complicated life activities at a molecular level, the search of such novel functional RNAs and the analyses thereof must hold important clues. An RNA study is playing a vital role in formation of a paradigm in the next generation of biological science.

For the study of functional RNA, the conventional study method of analyzing RNA as simple sequence information is insufficient. It has been known that RNA becomes mature as a result of various performing posttranscriptional modifications thereon, and thus that the RNA exhibits its original functions Approximately 100 types of RNA modifications have been reported to date (http://medstat.med.utah.edu/RNAmods/). Such RNA modifications are important qualitative information essential for the functions of RNA. Known roles of such RNA modification include determination of intracellular localization, stabilization of a three-dimensional structure, interaction with an RNA-binding protein, modification of gene information and unscrambling thereof, and the like (Suzuki, T. (2005) Biosynthesis and function of tRNA wobble modifications. In Fine-tuning of RNA functions by modification and editing Topics in Current Genetics, vol. 12, Springer-Verlag, N Y pg 24-69). However, in its functions and biosynthesis, many unexplained portions still remain. In order to correctly understand the functions of RNA, the conventional analysis method of grasping such RNA as “information” is insufficient, and it is essential to establish a new methodology of grasping an RNA molecule as an “article,” as in the case of a protein.

### DISCLOSURE OF THE INVENTION

### Problems to be Solved by the Invention

The post-genome age has arrived. The comprehensive analyses of biopolymers such as proteins or RNA have become important study targets in a wide range of fields such as life science, medical treatments or diagnoses. In order to clarify the functions of such biopolymers, it is essential to establish a method for full-automatically isolating and purifying a trace amount of protein or RNA existing in a living body. However, such isolation and purification of a trace amount of RNA is extremely difficult, and a common method therefor does not exist. It is an object of the present invention to provide a method for isolating biopolymers, which is capable of simultaneously isolating many types of biopolymers from a single biological sample under the same conditions.

### Means for Solving the Problems

As a result of intensive studies directed towards achieving the aforementioned object, the present inventors have conceived of a new concept “reciprocal circulating chromatography,” thereby completing the present invention.

That is to say, the present invention provides a method for isolating biopolymers, which comprises repeating at least twice a process consisting of:

(1) a step of preparing at least two vessels each containing a carrier retaining a substance having an affinity for a target biopolymer; then simultaneously introducing a single sample solution containing the target biopolymer(s) into at least the two vessels, and then allowing said sample solution to come into contact with said carrier, so that the target biopolymer can be adsorbed on said carrier;
(2) a step of discharging said sample solution from said vessels; and
(3) a step of stirring the discharged sample solution.

Preferably, the method for isolating biopolymers of the present invention comprises washing the said carrier with a washing solution and flowing an eluent, so as to recover the target biopolymer, after repeating the aforementioned steps (1) to (3) at least twice.

Preferably, at least 8 vessels are used.

Preferably, multiple types of different substances are used as the substances having an affinity for the target biopolymer.

Preferably, the target biopolymer is nucleic acid or a protein.

Preferably, the aforementioned steps (1) to (3) are repeated at least 10 times.

Preferably, in the above step (3), the discharged sample solution is stirred by any means selected from among pipetting, use of a stir bar, and shaking of the vessel.

Preferably, the above steps (2) and (3) are simultaneously carried out by pipetting.

Preferably, the vessel is a chip or a column.

In another aspect, the present invention provides a device used in isolation of biopolymers by the method of the present invention, which comprises:

at least two carrier-storing vessels for storing a carrier retaining a substance having an affinity for a target biopolymer;
a sample-storing vessel for storing a single sample solution containing the target biopolymer;
a means for introducing the sample solution into the carrier-storing vessels;
a means for discharging from the carrier-storing vessels, the sample solution introduced into said carrier-storing vessels; and
a means for stirring the sample solution in the sample-storing vessel.

### BEST MODE FOR CARRYING OUT THE INVENTION

The embodiments of the present invention will be described more in detail below.

### (1) Reciprocal Circulating Chromatography

The method for isolating biopolymers of the present invention is characterized in that it comprises repeating at least twice a process consisting of:

(1) a step of preparing at least two vessels each containing a carrier retaining a substance having an affinity for a target biopolymer; then simultaneously introducing a single sample solution containing the target biopolymer into at least the two vessels, and then allowing the above-described sample solution to come into contact with the above-described carrier, so that the target biopolymer can be adsorbed on the above-described carrier;
(2) a step of discharging the above-described sample solution from the above vessels; and
(3) a step of stirring the discharged sample solution

The method of the present invention is based on a reciprocal circulating chromatography. The summary of such a reciprocal circulating chromatography is as shown in FIG. 1. The reciprocal circulating chromatography of the present invention is based on a basic principle, in which an automatic dispenser equipped with a multipipetter is used, and in which the aspiration, discharge and stirring of samples are simultaneously repeated using multi-analyte affinity chips, so that all the sample solutions can be uniformly circulated to all the affinity chips. It is possible to simultaneously introduce the sample solution into multiple affinity chips by putting multiple affinity chips used for different target molecules (DNA-immobilization resin in the case of purification of RNA) to the multipipetter. In addition, by stirring the sample solution after suction and discharge, it becomes possible to purify a sample from the sample solution that is dozens of times larger than the amount of a solution aspirated or discharged, in principle. Moreover, the method of the present invention is particularly excellent in that an affinity chip is easily produced, and in that it enables automation of all the steps of adsorption, washing, and elution. Furthermore, by increasing the number of multipipetters, the number of analytes, which are simultaneously purified, can be easily increased. In examples as described later in the present specification, a 8-analyte automatic dispenser is used as a base, and a chip column filled with a DNA-immobilization resin is used, so that a full automatic RNA purification device can be achieved. Theoretical formulas used in such a reciprocal circulating chromatography (as described later in the present specification) were constructed using a model. Based on the affinity (equilibrium constant) of a ligand (DNA or an antibody) immobilized on a column for a target molecule (RNA or a protein), it is possible to estimate the final yield and the number of reciprocal circulations necessary for sufficient purification. Even in a case where an amount aspirated at once, the number of chip columns used, etc. is changed, the number of necessary reciprocal circulations can be easily calculated. The validity of this model was confirmed by experiments.

The substance having an affinity for the target biopolymer used in the present invention is a substance, to which the target biopolymer specifically binds. Examples of such a substance include various agents such as the nucleotide sequence of nucleic acid, a protein subunit, an enzyme inhibitor, hormone, or a neurotransmitter. The substance having an affinity for the target biopolymer can be bound to a carrier by a method that is commonly used in production of a carrier used for an affinity chromatography.

The method of the present invention is based on an affinity chromatography. In general, such an affinity chromatography can be carried out by allowing a target biopolymer contained in a sample to come into contact with a ligand (that is, a substance having an affinity for the target biopolymer) bound to a carrier under conditions in which a bond is generated due to such affinity, then washing the carrier to eliminate contaminants, and then eluting (dissociating) the target biopolymer bound to the ligand. Herein, washing and elution are generally carried out by filling a column with a carrier and then passing a washing solution and an eluent through the column. By passing the washing solution and eluent through the column, a liquid discharged from the column is fractionated, and a biopolymer contained in each fraction is quantified, thereby producing a chromatogram. In general, such a chromatogram can be produced by assigning the amount of a target biopolymer (which may be a relative amount) to the longitudinal axis, and also assigning the amount of an eluent (which may be an elution time when the amount of the eluent is dependent on the time) to the horizontal axis.

The type of a biopolymer is not particularly limited, and it can be selected, as appropriate, depending on the purpose. Examples of such a biopolymer include a protein, a lipoprotein, a glycoprotein, a polypeptide, a lipid, a polysaccharide, a lipopolysaccharide, a nucleic acid, and their complex.

The type of a sample solution that contains a biopolymer is not particularly limited. Examples of such a sample solution include a body fluid separated from a living body (e.g. blood, saliva, etc.), an extract of biological tissues, a cell extract, and a treated product thereof.

(2) Explanation about Theoretical Formulas Used in Reciprocal Circulating Chromatography

In order to examine the relationship between the number of reciprocal circulations and the final yield, using a model of such a reciprocal circulating chromatography, theoretical formulas were constructed. In order to estimate the number of necessary pipettings, taking into consideration the “efficiency of physically circulating a liquid”+“binding speed or efficiency,” theoretical formulas were constructed. Finally, recurrence formulas regarding Nn, the amount of a liquid bound to a chip after an n number of pipettings (or θn, the coverage of the chip), were obtained. Each parameter was determined as follows.

L: The total amount of a sample liquid (the amount of a liquid poured into a reservoir)
l: The amount of a liquid aspirated into a single chip by a single operation
n: The number of pipettings
Nn: The amount of a target molecule bound to a chip after an n number of pipettings
Nmax: The maximum amount of a target molecule bound to a chip
Cn: The concentration of a target molecule in a sample liquid after the n number of pipettings (the concentration of a substance to be obtained)
Cn′(t): The concentration of a target molecule in a liquid aspirated during an n^{th} number of pipetting (Cn′(0)=Cₙ₋₁, changed over time)
θn: Coverage of a chip after the n number of pipettings; the binding ratio in chip's bindable sites (θn=Nn/Nmax; θ0=0)
ka, kd: Velocity constant
K: Equilibrium constant
Theoretical Formula 1: Case where State Rapidly Reaches Equilibration

As shown in FIG. 2, a liquid having a concentration of Cn and an amount of L has been contained in a reservoir, and a product of interest has already bound to a chip at a ratio of θn. From the reservoir, liquid amount l is aspirated into the chip. In reality, it is considered that the aspiration rate of the chip, time required, etc. also have an influence on the binding rate. However, since mathematization of such factors is difficult, as approximation, they are substituted with a condition wherein a resin is uniformly mixed with the aspirated liquid. A product of interest with a concentration of Cn′ and a resin with a binding rate of θn are present in a liquid in an amount of 1, and the binding reaction of the product of interest progresses. Cn′ and θn are values that change over time. It is also possible to make a formula regarding a reaction rate and to calculate it. However, herein, on the assumption that the state rapidly reaches equilibration, a formula is simply derived. After a solution with a liquid amount of 1 has been aspirated and the state has reached equilibration in the resin, a solution with a liquid amount of 1 and a concentration of Cn′ is discharged. Thus, the discharged solution is mixed with a liquid remaining in a reservoir, so as to finally obtain a solution with a concentration of Cn and a liquid amount of L (Formula 1).

$${C}_{n} = \frac{{C}_{nl}^{′} + {C}_{n - 1} ( L - l )}{L} \qquad ( Formula 1 )$$

Subsequently, the relational formula between Cn and Cn−1 or θn and θn−1 is obtained. First, if a reaction formula is made in a state where the resin and the liquid are mixed during aspiration, while assuming equilibration, the following (Formula 2) is obtained. If an equilibrium constant is defined as K, the following (Formula 3) is obtained. In addition, the following (Formula 4) is obtained based on a balance regarding the liquid aspirated into a chip, and the following (Formula 5) that is a relational formula between Cn and θn is obtained based on the entire balance. Moreover, since nothing is bound at the initial stage, θ₀=0 (Formula 6).

$$\begin{matrix}{RNA \text{/} protein}_{{C}_{n}^{′}} + {Ligand}_{1 - {θ}_{n}} {\vec{←}}_{K} {Complex}_{{θ}_{n}} & ( Formula 2 ) \\ K = \frac{{θ}_{n}}{{C}_{n}^{′} ( 1 - {θ}_{n} )} & ( Formula 3 ) \\ {lC}_{n}^{′} = {lC}_{n - 1} + {N}_{max} {θ}_{n - 1} - {N}_{max} {θ}_{n} & ( Formula 4 ) \\ {C}_{n} = {C}_{0} - \frac{{N}_{max} {θ}_{n}}{L} & ( Formula 5 ) \\ {θ}_{0} = 0 & ( Formula 6 )\end{matrix}$$

When Formulas 4 and 5 are substituted into Formula 3, a quadratic equation is obtained. If θn is worked out, the following formula is finally obtained (Formula 7). Since a greater one of the two solutions is greater than 1, the solution must be only one. Bn was defined as follows (Formula 8). (This indicates the total amount of the product of interest existing in the chip during the n^{th} number of aspiration.)

$$\begin{matrix}{θ}_{n} = \frac{\begin{matrix}( {B}_{n} + {N}_{max} + \frac{l}{K} ) - \\ \sqrt{{( {B}_{n} + {N}_{max} + \frac{l}{K} )}^{2} - 4 {N}_{max} {B}_{n}}\end{matrix}}{2 {N}_{max}} & ( Formula 7 ) \\ {B}_{n} = λ {C}_{n - 1} + {N}_{max} {θ}_{n - 1} & ( Formula 8 )\end{matrix}$$

If the maximum binding amount (Nmax) of the chip and the equilibrium constant K are obtained, θ n can be calculated from θn−1. Thus, the binding amount obtained in each aspiration can be calculated.

In the case of K→∞, the following formula of θn in a case where the aspirated product binds to the chip at a percentage of 100% can be obtained (the maximum binding value).

In the case of Bn≧Nmax, θₙ=1.

In the case of Bu<Nmax, θₙ=θₙ₋₁+lCₙ₋₁/Nₘₐₓ.

The necessary number of aspirations and the obtained amount are changed, depending on the equilibrium constant K. FIG. 3 shows a change due to K in a case where the chip-bound amount is equal to the amount of the product of interest in the sample. (The amount of the sample is set to an excessive level, and the maximum chip-bound amount Nmax is estimated. Thereafter, the amount of the sample is set to a suitable value, and the operation is then carried out, so as to obtain the value of K.) The equilibrium constant K is an apparent value that includes conditions for the operation and the like, and thus it differs from a stringent equilibrium constant. However, it is possible to estimate a binding strength to the chip using such equilibrium constant K.

Theoretical Formula 2: Case where Reaction Rate is Considered

### Case of Considering a Reaction Rate (the Same Model was Applied)

When not equilibration but a reaction rate is considered, the following reaction formula is used (Formula 9).

If a formula regarding a reaction rate is made from Formula 9, Formula 10 can be obtained.

$$\begin{matrix}{RNA \text{/} protein}_{{C}_{n ( t )}^{′}} + {Ligand ( probe )}_{1 - {θ}_{n ( t )}} {{←}^{{\to }^{ka}}}_{ kd} {Complex}_{{θ}_{n ( t )}} & ( Formula 9 ) \\ \frac{d {θ}_{n} ( t )}{d t} = {k}_{a} {C}_{n}^{′} ( t ) ( 1 - {θ}_{n} ( t ) ) - {k}_{d} {θ}_{n} ( t ) & ( Formula 10 )\end{matrix}$$

The following formulas relate to the balance and the initial condition.

lCₙ′(t)=lCₙ₋₁+Nₘₐₓθₙ₋₁−Nₘₐₓθₙ(t) (Formula 11)

θₙ(0)=θₙ₋₁, θ₀=0 (Formula 12)

$${C}_{n} ( t ) = {C}_{0} - \frac{{N}_{max} {θ}_{n} ( t )}{L} \qquad ( Formula 13 )$$

The differential equation represented by Formula 10 is solved in terms of during the n^{th} number of aspiration. The relational formula regarding the balance is substituted therein, and if the solution is obtained in terms of θ, the following formula is obtained.

$${θ}_{n} ( t ) = \frac{\begin{matrix}( {a}_{n} - {θ}_{n - 1} ) {b}_{n} exp \{ \frac{{k}_{a}}{l} {N}_{max} ( {a}_{n} - {b}_{n} ) t \} - \\ {a}_{n} ( {b}_{n} - {θ}_{n - 1} )\end{matrix}}{\begin{matrix}( {a}_{n} - {θ}_{n - 1} ) {b}_{n} exp \{ \frac{{k}_{a}}{l} {N}_{max} ( {a}_{n} - {b}_{n} ) t \} - \\ ( {b}_{n} - {θ}_{n - 1} )\end{matrix}} \qquad ( Formula 14 )$$

an, bn, and Bn were defined as follows.
Bn indicates the total amount of the product of interest existing in the chip during the n^{th} number of aspiration.
bn indicates the maximum θ, which can be achieved during the n^{th} number of aspiration.

$$\begin{matrix} ( {b}_{n} = {lim}_{t \to ∞} {θ}_{n} ( t ) ) \\ {a}_{n} = \frac{( {B}_{n} + {N}_{max} + \frac{{k}_{d}}{{k}_{a}} l ) + \sqrt{\begin{matrix}{( {B}_{n} + {N}_{max} + \frac{{k}_{d}}{{k}_{a}} l )}^{2} - \\ 4 {N}_{max} {B}_{n}\end{matrix}}}{2 {N}_{max}} & ( Formula 15 ) \\ {b}_{n} = \frac{( {B}_{n} + {N}_{max} + \frac{{k}_{d}}{{k}_{a}} l ) - \sqrt{\begin{matrix}{( {B}_{n} + {N}_{max} + \frac{{k}_{d}}{{k}_{a}} l )}^{2} - \\ 4 {N}_{max} {B}_{n}\end{matrix}}}{2 {N}_{max}} & ( Formula 16 ) \\ {B}_{n} = {lC}_{n - 1} + {N}_{max} {θ}_{n - 1} = {lC}_{0} + ( 1 - \frac{l}{L} ) {N}_{max} {θ}_{n - 1} & ( Formula 17 )\end{matrix}$$

### (3) Use of the Present Invention

The present invention enables full automatic affinity column purification using a single analyte or multiple analytes. By immobilizing an antibody or a ligand on a column, it becomes possible to simultaneously purify multiple analytes of proteins (e.g. a transcription factor, a cancer gene product, an apoptosis-associated protein, etc.). By immobilizing complementary DNA or RNA on a column, it becomes possible to simultaneously purifying multiple analytes such as RNA (non-coding RNA, mRNA) or DNA. Moreover, by making an array at the tip of a chip column, it becomes possible to carry out microarray analysis using a large amount of sample. Furthermore, by immobilizing a protein, RNA, and DNA on a column, it becomes possible to simultaneously purify multiple analytes such as a protein complex, an RNA-binding protein, and a DNA-binding protein that interacts therewith. Otherwise, by immobilizing various types of lectin proteins on a column, it becomes possible to simultaneously purify multiple analytes such as a sugar chain, a glycoprotein, and a glycolipid. By immobilizing various types of sugar chains on a column, it also becomes possible to simultaneously purify multiple analytes such as proteins interacting therewith. By applying the aforementioned method, it becomes possible to conduct time-series analyses of cells that fluctuate due to disease, tissues, generation, or differentiation.

Still further, by immobilizing a compound library, it becomes possible to analyze proteins interacting therewith (chemical targeting proteome). Further, by immobilizing an antibody binding to a modified histone, a transcription factor, a nuclear protein, etc. on a column, it becomes possible to simultaneously perform chromatin immunoprecipitation on multiple analytes (multi ChIP), and it also becomes possible to carry out an epigenetic array by applying such multi ChIP. Further, by immobilizing an antibody binding to an RNA-binding protein on a column, it becomes possible to analyze the RNA binding to the purified protein. Furthermore, by immobilizing antibodies or ligands binding to a single protein on different columns, it becomes possible to perform a comparison analysis of the binding ability between ligands.

### (4) Multi ChIP Method Using Reciprocal Circulating Chromatography

Another application of the present invention is the development of a novel method (epigenetic array) for analyzing a genome-wide epigenetic control system, utilizing the advantage of the reciprocal circulating chromatography of the present invention. It is one of the most important objects in the post-genome age to clarify how all cells that constitute an individual organism achieve different characters, while maintaining single gene information. Epigenetics refers to an academic field, in which changes in gene function that occur without a change in the DNA sequence are studied. It has been known that the structural change of chromatin due to methylation of DNA and histone modification mainly controls genome-wide gene expression regulation. Chromatin is a complex having nucleosome repeat structures connected in a spiral manner. The nucleosome has a structure, in which DNA consisting of 146 base pairs twines twice around a histone octamer consisting of two molecules of 4 types of histone proteins (H2A, H2B, H3, and H4). It has been known that a histone consists of a core histone that forms a central portion of the nucleosome and a histone tail located at the N-terminus thereof, and that such a histone induces the structural change of chromatin as a result of undergoing various posttranslational modifications on the aforementioned histone tail portion, thereby regulating gene expression (FIG. 4). For example, it has been known that acetylation of K9 and K14 of histone H3 is closely correlated with induction of transcription. In contrast, methylation of K9 is related to gene silencing. Moreover, the histone undergoes various modifications, including not only acetylation but also methylation, phosphorylation, ubiquitination, etc., and it is associated with regulation of transcription, silencing, chromatin condensation, etc. To date, it has been reported that approximately 30 types of modifications have been found in such a histone tail portion (FIG. 4). In addition, recently, approximately 30 types of modifications have been found even in a core histone portion. It is considered that complicated gene expression regulation can be done based on the type of a histone, type of an amino acid residue of such a histone, the type of modification, and the combination thereof (Histone code hypothesis). Furthermore, in recent studies, it has been clarifying that RNAi is deeply associated with histone modification, and thus expanded RNA studies have been fusing with an epigenetic control system.

Chromatin immunoprecipitation (ChIP method) is a method, which comprises purifying a nucleosome by immunoprecipitation using various histone modifications as indicators and then analyzing the wound DNA. This is a method essential for analyzing gene expression regulation, the structural change of chromatin, etc. Not only an anti-modified histone antibody, but also antibodies binding to various DNA-bound transcription factors or non-bound proteins can be used. Thus, the ChIP method enables the analysis of a change in the histone modification state on a chromatin or a localized protein. At present, a method of immobilizing an anti-modified histone antibody on a resin and purifying fragmented nucleosomes by a batch method is commonly used. This method is simple. However, in principle, it is difficult for this method to keep adsorption or washing conditions constant. Thus, this method is not suitable for an analysis with emphasis on high reproducibility or quantitative performance. Hence, the present inventors have aimed to develop a full automatic multi-analyte chromatin immunoprecipitation method (multi ChIP method) using a reciprocal circulating chromatography (FIG. 5). Automation of the ChIP method enables easy control of temperature or time, and thus high reproducibility and quantitative performance are expected. Moreover, this full automatic muiti-analyte chromatin immunoprecipitation method is greatly advantageous in that it is able to isolate multiple types of modified nucleosomes from a single sample, utilizing the characteristic of a reciprocal circulating chromatography capable of isolating multiple types of target molecules from a single sample, using an affinity chip on which different anti-modified histone antibodies have been immobilized. For example, if a reciprocal circulating chromatography specialized for 48 analytes is used, and if affinity chips of 48 types of anti-modified histone antibodies are equipped therein, it can be anticipated that almost all types of modified nucleosomes can be simultaneously purified under the same conditions. The most advantage of this method is that many types of nucleosomes can be full-automatically purified from a limited amount of sample, such as cells or tissues derived from a patient. From the thus isolated each nucleosome, the DNA wound therearound is separated. Thereafter, such a DNA fragment is amplified by PCR using a primer set for amplifying the promoter region of a disease-related gene or a gene associated with generation and/or differentiation, so that a chromatin modification state or a fluctuation in the expression of a target gene can be monitored in a genome-wide manner (FIG. 5). Otherwise, after amplification of the purified nucleosome DNA, the amplified DNA is fluorescently labeled, so that detection on a DNA chip such as a genome tiling array can be carried out. This new method involving the combination of the multi ChIP method with an array is also referred to as an epigenetic array.

### (5) Characteristics of the Present Invention

As a result of the genome project, a new method and tool for comprehensively analyzing a fluctuation in the expression of all genes have been developed. Transcriptome analysis including a DNA chip as a representative example is effective as a means for analyzing a fluctuation in the expression of total mRNA. With regard to ncRNA as well, a microarray technique (including a genome tiling array) of comprehensively analyzing a fluctuation in expression has been developing. However, this is a method for analyzing the expression level of mRNA or ncRNA, and thus it is used to grasp a “quantitative change.” However, as described above, it has been known that functional RNA acquires functions as a result of modification. Thus, in order to grasp a “qualitative change,” it is necessary to develop a new method. Purification of an RNA molecule is a first step towards carrying out a qualitative analysis. However, there are no methods for purifying a trace amount of RNA. According to the method of the present invention, such a trace amount of RNA can be isolated, purified, and then analyzed. According to the method of the present invention for isolating biopolymers based on a reciprocal circulating chromatography, a full-automatic functional RNA purification device can be realized. In addition, although the ChIP method is a technique that has already been established, there are no techniques of isolating and purifying many types of nucleosomes from a single sample. A multi ChIP method and an epigenetic array, to which the reciprocal circulating chromatography of the present invention is applied, are completely new techniques of grasping the genome-wide structural change of chromatin. Thus, such a multi ChIP method and an epigenetic array are not only used as study tools, but also they are used in the development of a diagnostic device in a medical field.

The present invention will be more specifically described in the following examples. However, these examples are not intended to limit the scope of the present invention.

### EXAMPLES

### Example 1

### Simultaneous Purification of 3 Types of Escherichia coli Transfer RNAs (tRNAs) by Reciprocal Circulating Chromatography

### (1) Production of Chip

A 3′-end biotinylated DNA probe that was complementary to the sequence of each tRNA was allowed to bind to a Streptavidin Sepharose HP (Amersham) resin according to a common method.

### Sequences of Used Probes

(SEQ ID NO: 1)

For tRNA^{Lys}: TGGGTCGTGCAGGATTCGAACCTGCGACCA

(SEQ ID NO: 2)

For tRNA^{Glu}: CGTCCCCTAGGGGATTCGAACCCCTGTTA

(SEQ ID NO: 3)

For tRNA^{Asp}: CGGAACGGACGGGACTCGAACCCGCGACCC
For tRNA^{Lys}: 1.20 A260 unit/50 μl resin
For tRNA^{Glu}: 1.13 A260 unit/50 μl resin
For tRNA^{Asp}: 0.40 A260 unit/50 μl resin

A 300-μl chip was filled with a filter, and it was then filled with 50 μl of a resin, to which each probe had been bound. On such a resin, another filter used for an upper portion was placed with a slight gap.

### (2) Binding to Resin

As a sample solution, an RNA mixed solution produced by partial purification of the total RNA of Escherichia coli by ion exchange chromatography was used. Three chips were equipped in a 8-series manual pipette, and pipetting was then carried out several times by immersing them in a 6×NHE buffer (20×NHE consisted of 100 mM HEPES-KOH (pH 7.5), 50 mM EDTA, and 4 M NaCl) for equilibration. The sample solution was placed in a thermostatic bath made from metal, and it was then heated to 70° C. The chip was immersed in the sample solution that was kept at 70° C., and aspiration and discharge of 200 μl of the solution were then repeated 15 times. For every cycle, the vessel was shaken, so that stirring was carried out.

### (3) Washing

The chip was immersed in a vessel that contained 4 ml of 0.1×NHE buffer, and aspiration and discharge were repeated 5 times by hand. Further, 200 μl of 0.1×NHE buffer was prepared in a round-bottom plate in an amount of solution filled in 8 wells of each chip, and washing was then carried out with a solution prepared for each chip. For each well, pipetting was carried out twice.

### (4) Elution

Elution was carried out for individual chips, separately. Each chip was immersed in 1 ml of 0.1×NHE buffer that was kept at 65° C. in a thermostatic bath made from metal, and aspiration and discharge were then repeated 6 times. Thereafter, it was washed with 300 μl of 0.1×NHE buffer, and was then mixed with an eluent. After completion of the elution, annealing was carried out in the presence of an Mg ion for the unwinding of the structure. Thereafter, the purified product was recovered by ethanol precipitation.

### (5) Purified Amount

tRNA^{Lys}: 0.226 Au
tRNA^{Glu}: 0.421 Au
tRNA^{Asp}: 0.324 Au

The degree of purification of each product was confirmed by polyacrylamide gel electrophoresis (FIG. 6) and aminoacylation activity. As a result, it could be confirmed that the products were almost uniformly purified.

### Example 2

### Simultaneous Automatic Isolation of 8 Types of tRNAs of Escherichia coli

Using a reciprocal circulating chromatography device, 8 types of tRNAs of Escherichia coli were simultaneously and automatically isolated and purified. As targets, Escherichia coli tRNA^{Met}, tRNA^{fMet}, tRNA^{Phe}, tRNA^{Pro1}, tRNA^{Pro2}, tRNA^{Pro3}, tRNA^{Sec}, and tRNA^{Trp} were used.

### (1) Concerning Production of Reciprocal Circulating Chromatography Device

A reciprocal circulating chromatography device was produced by combining the following components, based on a 8-series multi-channel dispenser NSP-mini (Nichiryo Co., Ltd.).

Sample-stirring pump: PSP170AA peristaltic pump (ADVANTEC)

Water-supplying pump: QVG50-H1CTC-LF-type FMI pump (Yamazen Corp.)

Temperature controller: Biocell temperature controller BSTC-1 type and BSTC-2 type (Intecs, Sakaguchi-giken)

Personal computer used in production of program: Windows PC

In PSP170AA, ON and OFF can be controlled by external signals. Its I/O terminal was connected with the I/O connector of NSP-mini, so that the water-supplying direction of the pump and ON/OFF could be controlled by the program on the dispenser side.

The Biocell temperature controller is configured such that two 96-well heat blocks (Sakaguchi-giken) and a 2-ml reciprocal circulation thermostatic bath (Sakaguchi-giken) can be connected with the temperature controller. The 96-well heat block is configured such that it can be equipped with 1.1-ml tubes, and the reciprocal circulation thermostatic bath is configured such that it can be equipped with a 2-ml plastic reservoir.

The FMI pump is a pump for compensating the evaporated water, and it supplies water to the reciprocal circulation bath. It was operated by hand, as necessary.

The operation program was produced on the personal computer using MSS-mini editor (Nichiryo Co., Ltd.), and it was then transferred to the dispenser side.

Used buffer:

### 20×NHE Buffer

### 4M NaCl

### 100 mM HEPES-KOH (pH 7.5)

### 50 mM EDTA (pH 8.0)

The aforementioned 20×NHE was diluted, so as to use it as 6×NHE, 2×NHE, 0.5×NHE, and 0.1×NHE. To a solution that contained tRNA, dithiothreitol (DTT) was added to a concentration of 0.5%. In addition, when the chip was conserved, sodium azide was added thereto to a concentration of 0.1%, and it was then conserved.

### (2) Production of Chip Column

A chip, to which RNA was to be bound, was produced by filling it with a commercially available resin.

A small amount of quartz wool was filled in the tip of a 300-μl chip (Axygen), and water was then supplied thereto. Thereafter, 70 μl of 50% suspension of Streptavidin Sepharose HP (Amersham) was placed in the chip. The chip was left at rest for a while, and after the resin had sunk, the buffer was placed in the chip, such that the chip could be filled with a liquid. Further, a small amount of quartz wool was placed thereon to prevent air from leaking therein, and it was then pushed therein with a stick. Thus, the chip was formed, such that the resin could be sandwiched with the quartz wool at the upper and lower portions. A silicon tube (inside diameter: 2 mm; and outside diameter: 4 mm) was cut into a length of 1 to 2 mm. The thus cut tube was filled into the chip from the top thereof, so as to prevent the resin or quartz wool from coming away from the upper portion. The silicon tube was allowed to closely come into contact with the quartz wool. 6×NHE was passed through the chip, so that the buffer was substituted therewith. A state where an appropriate amount of buffer was always kept at the upper portion of the chip was maintained, so as not to dry up the chip. Thereafter, the routine proceeded to the next step.

### (3) Immobilization of Probe

As a probe, 3′-biotin-modified 30-mer oligo DNA (Hokkaido System Science Co., Ltd.) was used. It was then bound to a resin by the interaction between avidin and biotin. The sequences of such probes were designed, such that a probe complementary to each tRNA can be as specific as possible for the tRNA.

### <Sequences of Used Probes>

| | |
|---|---|
| Met | |
| TGGCTACGACGGGATTCGAACCTGTGACCC | (SEQ ID NO: 4) |
| fMet | |
| GTTATGAGCCCGACGAGCTACCAGGCTGCT | (SEQ ID NO: 5) |
| Phe | |
| TGCCCGGACTCGGAATCGAACCAAGGACAC | (SEQ ID NO: 6) |
| Pro1 | |
| CCTTCGTCCCGAACGAAGTGCGCTACCAGG | (SEQ ID NO: 7) |
| Pro2 | |
| CCCGACACCCCATGACGGTGCGCTACCAGG | (SEQ ID NO: 8) |
| Pro3 | |
| CACTGGTCCCAAACCAGTTGCGCIACCAAG | (SEQ ID NO: 9) |
| Sec | |
| CGGAAGATCACAGGAGTCGAACCTGCCCGG | (SEQ ID NO: 10) |
| Trp | |
| CAGGGGCGGAGAGACTCGAACTCCCAACAC | (SEQ ID NO: 11) |

Such probes were bound to the chip using a dispenser.

A 96-well round-bottom plate was placed on a dispenser, and 2 OD unit of each probe was prepared in the 1^{st} line, to a final concentration of 2×NHE and a liquid amount of 240 μl. In addition, for washing, 400 μl each of 2×NHE was dispensed in a 96-well heat block, and it was then heated to 40° C. (Twelve 2×NHE were used for a single chip.) 2×NHE was placed in a reservoir used for equilibration.

Subsequently, the following program was produced, and it was then carried out by a dispenser:

(i) Equilibration: The pipetting of 2×NHE with a reservoir 3 times;
(ii) Binding: The pipetting of a probe solution on a plate 20 times; and
(iii) Washing: The pipetting of 400 μl of 2×NHE at 40° C. 3 times (Washing is carried out by transferring the chip columns to new tubes filled with 2×NHE and it is repeated 12 times in total.).

The absorbance of each fraction was measured, and whether or not the washing had been sufficiently carried out was confirmed. At the same time, the amount of the bound probe was calculated. The results are shown below

TABLE 1

| | Met | fMet | Phe | Pro1 | Pro2 | Pro3 | Sec | Trp |
|---|---|---|---|---|---|---|---|---|
| Bound | 1.67 | 1.63 | 1.27 | 1.60 | 1.45 | 1.55 | 1.57 | 1.61 |
| amount | | | | | | | | |
| (OD unit) | | | | | | | | |

(4) Purification of tRNAs by Reciprocal Circulation

400 OD) unit of Escherichia colt tRNA (Roche) was prepared in a reciprocal circulation bath, to a final concentration of 6×NHE 0.5% OTT and a liquid amount of 2 ml. 96 sets of 400 μl each of 0.5×NHE 0.5% DTT for washing were dispensed in one heat block. On the other hand, 48 sets of 400 μl each of 0.1×NHE 0.5% DTT for elution were dispensed in the other heat block. 6×NHE 0.5% DTT was prepared in a reservoir. The reciprocal circulation bath was set at 70° C., the heat block for washing was set at 40° C., and the heat block for elution was set at 68° C. For stirring, a Perista pump and a tube were established. One end of the tube was connected with the reciprocal circulation bath, and the other end was connected with a vessel for temporarily storing a solution. At the time of stirring, all the solution contained in the reciprocal circulation bath is once transferred to the other vessel, so that the solution could be homogenized. Thereafter, the Perista pump was inversely rotated, so that the solution was returned to the original reciprocal circulation bath. Moreover, a water-supplying pump was connected, such that it could supply water to a vessel, which was used during stirring. The pump was driven at an adequate speed, so as to prevent a change in a liquid amount when the tRNA solution remained in the reciprocal circulation bath.

Subsequently, the following program was produced, and it was then carried out by a dispenser:

(i) Equilibration: The pipetting of 6×NHE with a reservoir 3 times;
(ii) Reciprocal circulation: The pipetting of the tRNA solution 40 times (For every pipetting, the solution is aspirated by a Perista pump to return to the original position, followed by stirring. The latency time is set, such that the temperature of the solution can be kept at approximately 66° C.);
(iii) Washing: The pipetting of 400 μl of 0.5×NHE at 40° C. 3 times (The chip columns are successively transferred to new tubes, and washing is repeated 12 times in total.); and
(iv) Elution: The pipetting of 400 μl of 0.1×NHE at 68° C. 3 times (The chip columns are successively transferred to new tubes, and elution is repeated 6 times in total.).

The absorbance of each fraction was measured, and whether or not the washing had been sufficiently carried out was confirmed. Thereafter, each of the eluted RNAs was recovered by ethanol precipitation, and the absorbance was measured. The results are shown below.

TABLE 2

| tRNA | Met | fMet | Phe | Pro1 | Pro2 | Pro3 | Sec | Trp |
|---|---|---|---|---|---|---|---|---|
| Purified | 3.54 | 4.28 | 2.35 | 3.32 | 1.52 | 1.89 | 1.11 | 2.26 |
| amount | | | | | | | | |
| (OD unit) | | | | | | | | |

Polyacrylamide electrophoresis was carried out to confirm that each RNA was obtained at a nearly uniform purification degree, except for tRNASec. Moreover, a portion was cut out of the polyacrylamide gel, was purified, and was then digested with RNaseT1. The thus obtained product was analyzed by LC/MS, and it was confirmed that it was a product of interest.

### Example 3

### Simultaneous Automatic Isolation of 8 Types of Non-Coding RNAs of Budding Yeast

Using a reciprocal circulating chromatography device, 8 types of non-coding RNAs of budding yeast (S. cerevisiae) were simultaneously and automatically isolated and purified. As targets, U4 RNA, U6 RNA, 7SL RNA (SCR1), SNR5, SNR9, SNR128, SNR190, mitochondrial tRNA^{Met} were used.

### <Sequences of Used Probes>

| | |
|---|---|
| U4 RNA: | |
| CACTGATATGCGTATTTCCCGTGCATAAGG | (SEQ ID NO: 12) |
| U6 RNA: | |
| CATCCTTATGCAGGGGAACTGCTGATCATC | (SEQ ID NO: 13) |
| SCR1: | |
| ACGCTGGATAAAACTCCCCTAACAGCGGTG | (SEQ ID NO: 14) |
| SNR5: | |
| TATAGACATATGGAGGCGTGATGTCTTAAG | (SEQ ID NO: 15) |
| SNR9: | |
| GACTAATGATAGGTGGGTCAGGATATCAGC | (SEQ ID NO: 16) |
| SNR128: | |
| CCGTGGAAACTGCGAATGTTAAGGAACCAG | (SEQ ID NO: 17) |
| SNR190: | |
| GCTCAGATCTGCATGTGTTGTATAACACTG | (SEQ ID NO: 18) |
| mt tRNA^{Met}: | |
| TTATTTATTTATGAGACAAATGTTTTAACC | (SEQ ID NO: 19) |

### (1) Production of Chip Column

A chip column was produced in the same manner as that in Example 2.

### (2) Immobilization of Probe

A probe was immobilized on the chip in the same manner as that in Example 2. The results obtained by measuring the bound amount are shown below.

TABLE 3

| | | | | | | | | mt |
|---|---|---|---|---|---|---|---|---|
| | U4 | U6 | SCR1 | SNR5 | SNR9 | SNR128 | SNR190 | tRNA^{Met} |
| Bound | 1.28 | 1.27 | 1.20 | 1.37 | 1.36 | 1.22 | 1.11 | 1.25 |
| amount | | | | | | | | |
| (OD unit) | | | | | | | | |

### (3) Purification of Non-Coding RNAs by Reciprocal Circulation

An RNA solution was produced by culturing yeast, extracting with phenol, and then roughly purifying by anion exchange column chromatography. 200 OD unit of the RNA solution was prepared in a reciprocal circulation bath, to a final concentration of 3×NHE 0.5 mM DTT and a liquid amount of 2 ml. The temperature was set at 50° C. Other conditions were the same as those applied in Example 2.

Subsequently, the following program was produced, and it was then carried out by a dispenser:

(i) Equilibration: The pipetting of 6×NHE with a reservoir 3 times;
(ii) Reciprocal circulation: The pipetting of the tRNA solution of 3×NHE at 50° C. 50 times (For every pipetting, the solution is aspirated by a Perista pump to return to the original position, followed by stirring. The latency time is set, such that the temperature of the solution can be returned to the preset temperature.);
(iii) Washing: The pipetting of 400 μl of 0.5×NHE at 40° C. 3 times (The chip columns are successively transferred to new tubes, and washing is repeated 12 times in total.); and
(iv) Elution; The pipetting of 400 μl of 0.1×NHE at 68° C. 3 times (The chip columns are successively transferred to new tubes, and elution is repeated 6 times in total).

The absorbance of each fraction was measured, and whether or not the washing had been sufficiently carried out was confirmed. Thereafter, each of the eluted RNAs was recovered by ethanol precipitation. As a result of performing polyacrylamide electrophoresis, it was confirmed that each RNA had been purified (FIG. 7). Moreover, a portion was cut out of the polyacrylamide gel, was purified, and was then digested with RNaseT1. The thus obtained product was analyzed by LC/MS, and it was confirmed that it was a product of interest.

### Example 4

### Multi ChIP Method Using Reciprocal Circulating Chromatography

A tip column where 5 types of anti-modified histone antibody and anti-RNA polymerase II antibody were immobilized was placed on the reciprocal circulating chromatography device, and chromatin derived from HeLa cells was purified. Evaluation after purification was cried out by quantifying the promoter region of GAPDH gene by real-time PCR

(1) Culture of HeLa cells

HeLa cells were cultured in DMEM medium containing 10% Fatal Bovine Serum under a condition of 37° C. and 5% CO₂, and were used

### (2) Antibodies

All antibodies used in ChIP were purchased from Upstate. 2 μl of Anti-RNA polymerase II (05-623), and 5 μl of each of Anti-monomethyl-Histone H3 (Lys4) (07-436), Anti-dimethyl-Histone H3 (Lys4) (07-441), Anti-trimethyl-Histone H3 (Lys4) (07-473), Anti-phospho-Histone H3 (Ser10) (05-817), Anti-trimethyl-Histone H3 (Lys27) (07-449) and Normal mouse IgG (12-371), were used.

### (3) Preparation of Chromatin Solution

Formaldehyde was added to 4.5×10⁷ HeLa cells at a final concentration of 1%, and the cells were left stand at room temperature for 10 minutes. Then, a glycine solutin was added at a final concentration of 0.125M, and the treatment was carried at room temperature for 5 minutes. After washing with PBS, 1 ml of PBS/1 mM PMSF was added, and the cells were collected by a cell scraper, and were centrifuged at 1000 g for 4 minutes. The obtained cells were added with 1,800 μl of Lysis buffer (50 mM Tris-HCl (pH 8.0), 10 mM EDTA (pH 8.0), 1% SDS)/1 mM PMSF/1 μg/ml aprotinin), and were left stand on ice for 10 minutes. Then, 300 μl of the cells were dispensed into 1.5 ml Eppendorf tube, and were subjected to sonication. The sonication was carried out using Sonifier (Branson Ultrasonics Corporation) under condition of output 3, 5 sec, 33% and 2 min, so that genome DNA fragments can be most frequently found at 200-800 bp in the EtBr staining. This sample was centrifuged at 20,000 g for 15 minutes at 8° C., and the supernatant was added with 16.2 mL (9 times volume) of ChIP dilution buffer (16.7 mM Tris-HCl (pH8.0), 1.2 mM EDTA (pH 8.0), 167 mM NaCl, 0.01% SDS, 1.1% Triton X-100), and further pre-cleared with 500 μL of Protein G Agarose/salmon sperm DNA (Upstate 16-201) to prepare a chromatin solution. In the case where ChIP is carried out in Eppendorf tube, an antibody is first added to 500 μl of chromatin solution, and is incubated overnight at 4° C. Then 40 μl of Protein G Agarose/salmon sperm DNA was added, and the mixture was incubated for 1 hour at 4° C. Then, this Protein G Agarose/salmon sperm DNA was washed once with each of 1 ml of Low salt buffer, High salt buffer, and LiCl buffer, respectively, and was washed twice with TE buffer. Then, 300 ml of Elution buffer was added, and the mixture was strongly stirred at room temperature for 30 minutes, so that eluting was carried out. Then, (7) Purification of immuno-precipitated fraction” below is referred to.

### (4) Preparation of Chip Column

Siliconized quartz wool was immersed in TE Buffer or PBS (in case of cross-linking), and was charged into 300 μl tip (AXYGEN T-350-C-L-R). Then, 40 μl of Protein G Agarose/salmon sperm DNA was laminated thereon, and quartz wool was laminated, and finally silicone tube (2 mm×4 mm) was placed and fixed. Further, in order to prevent the resin from drying, the tip was filled with TE buffer or PBS.

### (5) Comparison Between the Reciprocal Circulating Procedure and the Separate Procedure

The chip column was set on 8 run pipette, and the program was carried out. The programs for Separate procedure and the reciprocal circulating procedure are mentioned below. The “Separate” indicates a procedure where a chromatin solution is set on different tubes in each tip column, and the procedure is carried out in such a way that each solution is not mixed with each other, which is used for the comparison with the reciprocal circulating procedure. Further, in the reciprocal circulating procedure, stirring by peristaltic pump was carried out at each of pipetting of the chromatin solution. In the Separate procedure, 500 μl of chromatin solution was used per tip. In the reciprocal circulating procedure, 2.0 ml of chromatin solution was used per tip. The buffer compositions used in the program are shown after the program.

TABLE 4

| No. | Buffer and the like | Volume (μl) | Number of pipetting |
|---|---|---|---|
| 1 | TE × 2 times | 500 | 10 |
| 2 | TE + antibody | 300 | 60 |
| 3 | Low salt buffer | 500 | 10 |
| 4 | High salt buffer | 500 | 10 |
| 5 | LiCl buffer | 500 | 10 |
| 6 | Lysis buffer + ChIP dilution | 500 | 10 |
| | buffer (1:9) × 2 | | |
| 7 | Chromatin solution | 500 | 60 |
| 8 | Low salt buffer × 3 | 500 | 10 |
| 9 | High salt buffer × 3 | 500 | 10 |
| 10 | LiCl buffer × 3 | 500 | 10 |
| 11 | TE buffer × 5 | 500 | 10 |
| 12 | Elution buffer | 300 | 30 |

Cross-linking buffer: 0.2 M Sodium Borate (pH 8.0)
Blocking buffer: 0.1 M ethanotamine (pH 8.1)
Low salt buffer: 20 mM Tris-HCl (pH8.0), 2 mM EDTA (pH8.0), 150 mM NaCl, 1.0% Triton X-100, 0.1% SDS
High salt buffer: 20 mM Tris-HCl (pH8.0), 2 mM EDTA (pH8.0), 500 mM NaCl, 1.0% Triton X-100, 0.1% SDS
LiCl buffer: 10 mM Tris-HCl (pH 8.0), 1 mM EDTA (pH 8.0), 250 mM LiCl, 1.0% NP-40, 1% Deoxycholate
Elution buffer: 1% SDS, 0.1 M NaHCO₃

### (6) Effect of Cross-Linking of Antibody and Resin

As is different from the aforementioned Separate procedure and the reciprocal circulating procedures a step of a cross-linking reaction by DSS is added. The antibody is bound to the resin more strongly by the cross-linking, and thus it is prevented that the antibody flows out from the chip.

TABLE 5

| No. | Buffer and the like | Volume (μl) | Number of pipetting |
|---|---|---|---|
| 1 | PBS × 2 times | 500 | 10 |
| 2 | PBS + antibody | 300 | 60 |
| 3 | Cross-linking buffer | 500 | 10 |
| 4 | Cross-linking buffer + | 500 | 60 |
| | DSS (2.5 mM) | | |
| 5 | Blocking buffer | 500 | 10 |
| 6 | Blocking buffer | 500 | 60 |
| 7 | Low salt buffer | 500 | 10 |
| 8 | High salt buffer | 500 | 10 |
| 9 | LiCl buffer | 500 | 10 |
| 10 | Lysis buffer + ChIP dilution | 500 | 10 |
| | buffer (1:9) × 2 | | |
| 11 | Chromatin solutin | 500 | 60 |
| 12 | Low salt buffer × 3 | 500 | 10 |
| 13 | High salt buffer × 3 | 500 | 10 |
| 14 | LiCl buffer × 3 | 500 | 10 |
| 15 | TE buffer × 5 | 500 | 10 |
| 16 | Elution buffer | 300 | 30 |

### (7) Purification of Immuno-Precipitated Fraction

12 μl of 5 M NaCl was added to the obtained 300 μl of the immuno-precipitated fraction, and the mixture was incubated at 65° C. for 6 hours or more. Further, 30 μl of chromatin solution was taken as an input, and 270 μl of Elution buffer was added thereto, and the mixture was treated in the same way. Then, 1.5 μl of 10 mg/ml RNase A was added, and incubated at 37° C. for 1 hour. Then, treatment with proteinase K (1.5 μl of 10 mg/ml proteinase K, 12 μl of Tris-HCl (pH6.5), and 6 μl of 0.5M EDTA are added) was carried out at 45° C. for 1 hour. DNA was purified from the obtained solution by QIAquick spin column (QIAGEN), and was eluted with 50 μl of milliQ, and was used as template for PCR.

### (8) Quantitative PCR

Quantitative PCR was carried out using SYBR premix (Takara Bio Inc.) in LightCycler480 (Roche Applied Science). The reaction program and the reaction composition are shown below. The primers which were designed to correspond to about 120 bp region containing a promoter and transcription initiation point of GAPDH gene, were used. The sequences of these primers are Fw: CGT AGC TCA GGC CTC AAG AC (SEQ ID NO:20) and Rv: GCT GCG GGC TCA ATT TAT AG (SEQ ID NO:21). The recovery rate by the antibody was calculated from the differences of Cp values of the immuno-precipitated fraction and the input chromatin solution. The calculation was carried out on the basis that the difference of Cp value by 1 indicates the difference of 2 times the amount.

Reaction program
Denature: 96° C., 20 seconds
Amplification reaction: 45 cycles of 95° C., 6 seconds [symbol] 60° C., 40 seconds

### Reaction Composition

| | |
|---|---|
| 2x SYBR premix | 10.0 μl |
| 20 μM primer Fw | 0.4 μl |
| 20 μM primer Rv | 0.4 μl |
| milliQ | 4.6 μl |
| template | 5.0 μl |
| total | 20.0 μl |

### (9) Result

ChIPs were carried out by Separate, reciprocal circulating, or reciprocal circulating with a cross-linking agent, and each genome DNA purified from immuno-precipitated fraction or input was used as a template to perform quantitative PCR on the promoter region of GAPDH gene, and the results were compared with the input. The results are shown in the following Table and FIG. 8.

TABLE 6
Analysis of promoter region of GAPDH gene

| | | | reciprocal |
|---|---|---|---|
| | | | circulating + |
| | Separate | reciprocal circulating | cross-linking |
| RNA pol II | 20.17 | 20.59 | 21.61 |
| Monome-H3Lys4 | 2.08 | 2.90 | 2.63 |
| Dime-H3Lys4 | 10.08 | 17.43 | 11.83 |
| Trime-H3Lys4 | 4.97 | 9.54 | 6.29 |
| Phosphor-H3S10 | 1.96 | 3.30 | 3.15 |
| Trime-H3Lys27 | 1.72 | 2.92 | 2.63 |
| IgG | 1.79 | 3.96 | 2.74 |

The almost same result as in the conventional method was obtained by the treatment with a cross-linking agent in the multi ChIP method using reciprocal circulating chromatography

### INDUSTRIALLY APPLICABILITY

The method for isolating biopolymers of the present invention is a method for purifying biopolymers based on a totally new concept called “reciprocal circulating chromatography.” According to the method of the present invention, it is possible to simultaneously isolate many types of biopolymers from a single biological sample under the same conditions. In addition, the method of the present invention is advantageous in that it enables automation of affinity chromatography, which comprises a complicated purification process and which has difficulty in condition setting. Examples of application of the present invention include an automatic purification device of functional RNA, an automatic multi IP (immunoprecipitation) device, and multi ChIP (chromatin immunoprecipitation method) for measuring comprehensive expression regulation in the genome as a whole and an epigenetic array using the same.

### BRIEF DESCRIPTION OF THE DRAWINGS

FIG. 1 is a schematic diagram of the reciprocal circulating chromatography of the present invention. In the affinity chip, different types of DNA probes, antibodies and the like are bound to each carrier.

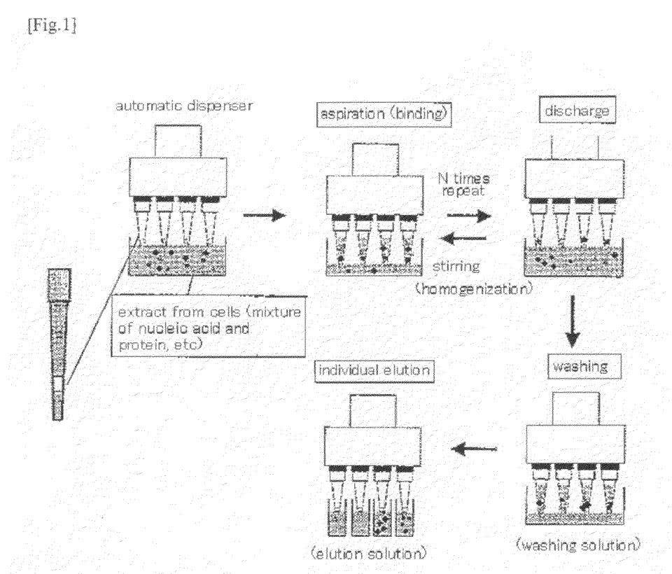

FIG. 2 shows a state immediately before an n^{th} number of pipetting. Cn′ represents the concentration of a liquid under aspiration, and Cn represents the concentration (reservoir concentration) after discharged and mixed with other liquid.

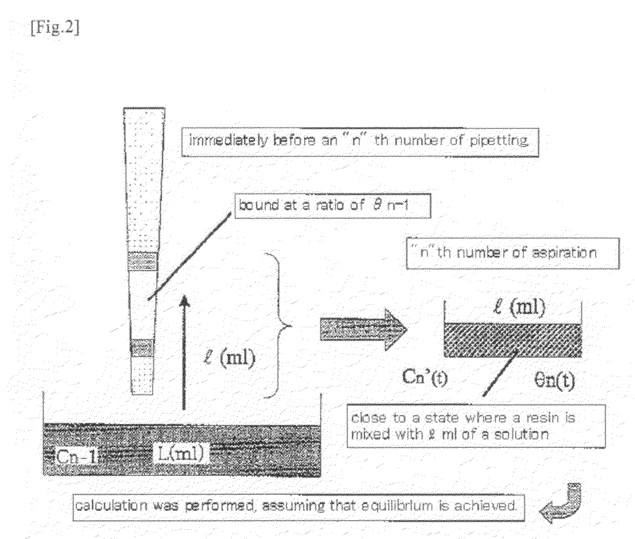

FIG. 3 shows a change in a necessary number and a binding rate based on an equilibrium constant.

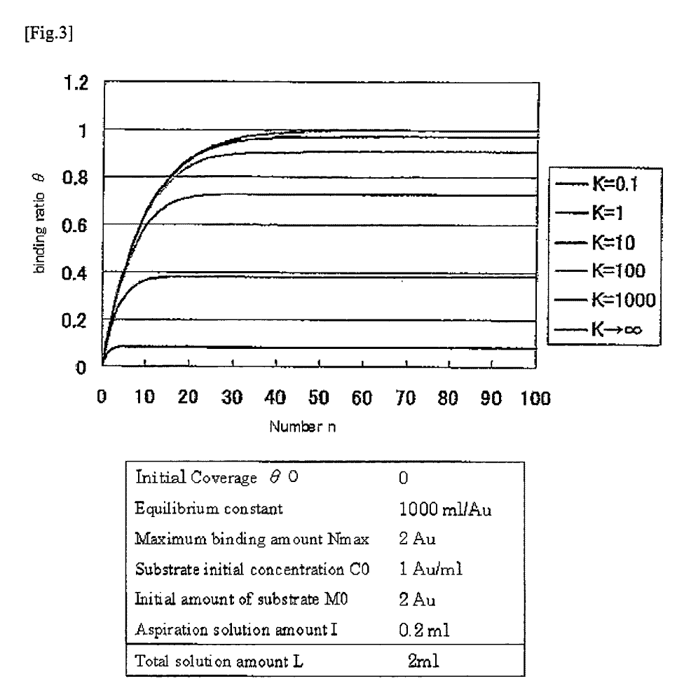

FIG. 4 shows histone tail modification. Modification of the histone tail is temporally and spatially controlled for every cell.

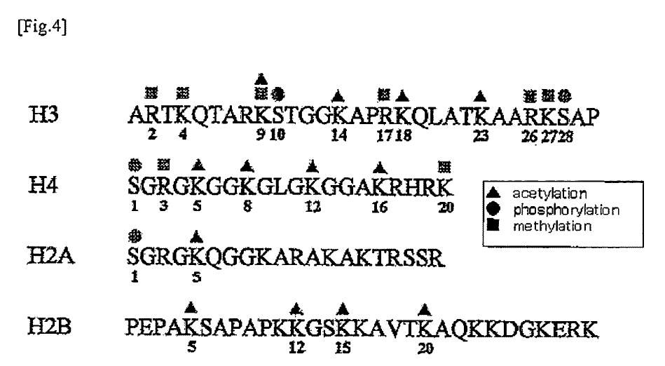

FIG. 5 shows a multi ChIP method and an epigenetic array. Multiple modified nucleosomes are purified by multi ChIP using a reciprocal circulating chromatography, and a histone modification state in each gene, which fluctuates based on generation and/or differentiation or a disease, is comprehensively analyzed (epigenetic array).

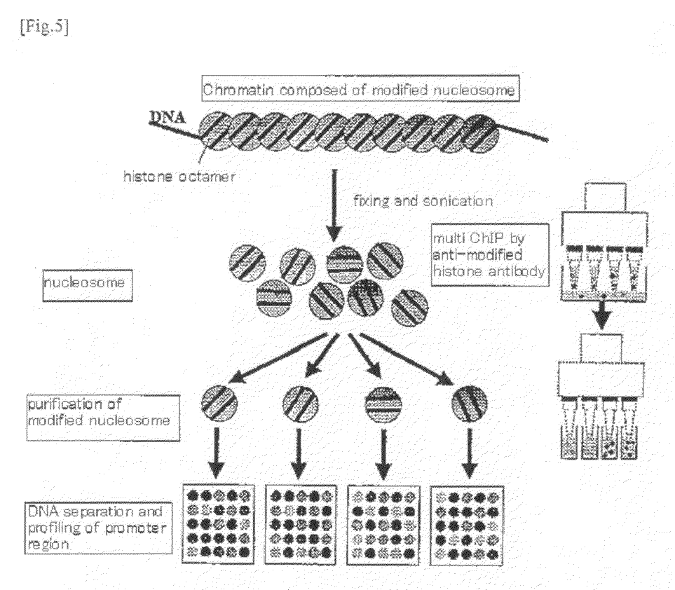

FIG. 6 shows tRNAs that have been simultaneously purified by the present invention. 1: a passing-through fraction; 2: a wash fraction; 3: eluted tRNA^{Lys}; 4: eluted tRNA^{Glu}; and 5: tRNA^{Asp}. In the case of 5 above, the fraction is separated to two bands, but they are conformers and also a single molecule.

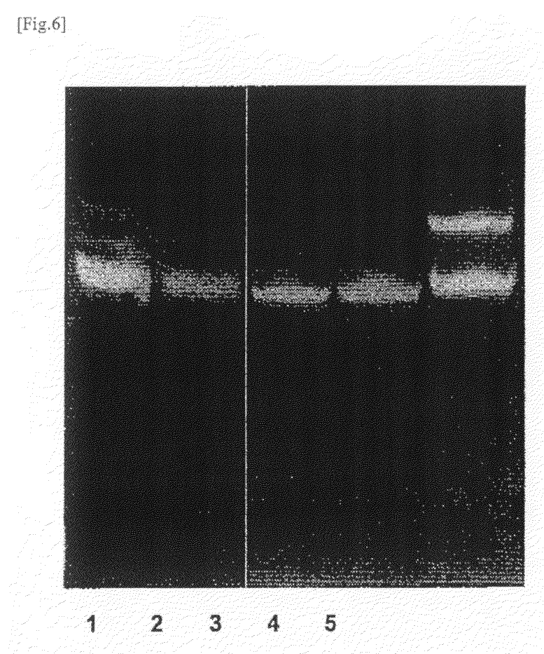

FIG. 7 is an example of purifying yeast ncRNA by a reciprocal circulating chromatography. 8 types of minor ncRNAs, such as a low-molecular-weight RNA in nucleus and nucleolus, were isolated from a total RNA fraction. All the steps, starting from production of an affinity chip, were carried out in a full automatic manner.

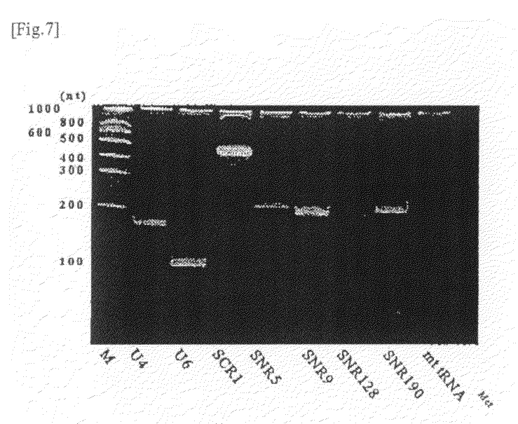

FIG. 8 is an example of analysis of multi ChIP process by a reciprocal circulating chromatography. Each of chromatins which were purified by 5 types of anti-modified histone antibodies, anti RNA polymerase II antibody or unimmunized mouse IgG (control) was evaluated by quantitative PCR in the promoter region of GAPDH gene. The longitudinal axis indicates the percentage (%) of the immuno-precipitated genome amount to the input, and the transverse axis indicates the used antibody. The Separate (black), reciprocal circulating (gray), and reciprocal circulating+cross-linking (white)

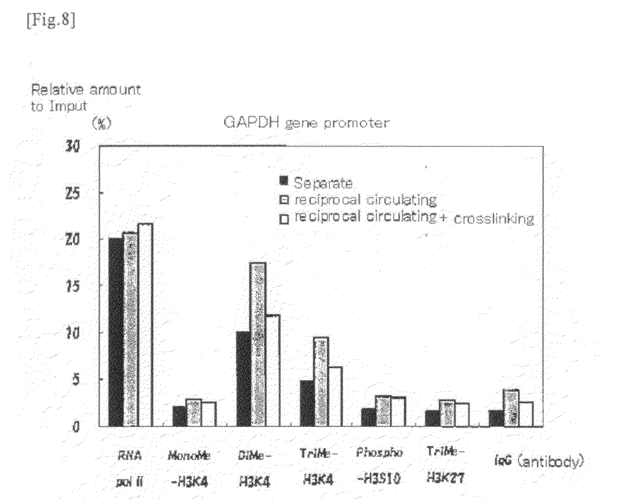

1. A method for isolating biopolymers, which comprises repeating at least twice a process consisting of:
(1) a step of preparing at least two vessels each containing a carrier retaining a substance having an affinity for a target biopolymer; then simultaneously introducing a single sample solution containing the target biopolymer(s) into at least the two vessels, and then allowing said sample solution to come into contact with said carrier, so that the target biopolymer can be adsorbed on said carrier;
(2) a step of discharging said sample solution from said vessels; and
(3) a step of stirring the discharged sample solution.

2. The method for isolating biopolymers according to claim 1 which comprises washing the said carrier with a washing solution and flowing an eluent, so as to recover the target biopolymer, after repeating the aforementioned steps (1) to (3) at least twice.

3. The method for isolating biopolymers according to claim 1 wherein at least 8 vessels are used.

4. The method for isolating biopolymers according to claim 1 wherein multiple types of different substances are used as the substances having an affinity for the target biopolymer.

5. The method for isolating biopolymers according to claim 1 wherein the target biopolymer is nucleic acid or a protein.

6. The method for isolating biopolymers according to claim 1 wherein the steps (1) to (3) are repeated at least 10 times.

7. The method for isolating biopolymers according to claim 1 wherein, in the step (3), the discharged sample solution is stirred by any means selected from among pipetting, use of an agitator, and shaking of the vessel.

8. The method for isolating biopolymers according to claim 1 wherein the steps (2) and (3) are simultaneously carried out by pipetting.

9. The method for isolating biopolymers according to claim 1 wherein the vessel is a chip or a column.

10. A device used in isolation of biopolymers by the method of claim 1, which comprises:
at least two carrier-storing vessels for storing a carrier retaining a substance having an affinity for a target biopolymer;
a sample-storing vessel for storing a single sample solution containing the target biopolymer;
a means for introducing the sample solution into the carrier-storing vessels;
a means for discharging from the carrier-storing vessels, the sample solution introduced into said carrier-storing vessels; and
a means for stirring the sample solution in the sample-storing vessel.


SEQUENCE LISTING (25 sequences)

SEQ ID NO: 1 - DNA, 30 bp, Artificial Sequence
  Description of Artificial Sequence Synthetic probe
tgggtcgtgcaggattcgaacctgcgacca

SEQ ID NO: 2 - DNA, 29 bp, Artificial Sequence
  Description of Artificial Sequence Synthetic probe
cgtcccctaggggattcgaacccctgtta

SEQ ID NO: 3 - DNA, 30 bp, Artificial Sequence
  Description of Artificial Sequence Synthetic probe
cggaacggacgggactcgaacccgcgaccc

SEQ ID NO: 4 - DNA, 30 bp, Artificial Sequence
  Description of Artificial Sequence Synthetic probe
tggctacgacgggattcgaacctgtgaccc

SEQ ID NO: 5 - DNA, 30 bp, Artificial Sequence
  Description of Artificial Sequence Synthetic probe
gttatgagcccgacgagctaccaggctgct

SEQ ID NO: 6 - DNA, 30 bp, Artificial Sequence
  Description of Artificial Sequence Synthetic probe
tgcccggactcggaatcgaaccaaggacac

SEQ ID NO: 7 - DNA, 30 bp, Artificial Sequence
  Description of Artificial Sequence Synthetic probe
ccttcgtcccgaacgaagtgcgctaccagg

SEQ ID NO: 8 - DNA, 30 bp, Artificial Sequence
  Description of Artificial Sequence Synthetic probe
cccgacaccccatgacggtgcgctaccagg

SEQ ID NO: 9 - DNA, 30 bp, Artificial Sequence
  Description of Artificial Sequence Synthetic probe
cactggtcccaaaccagttgcgctaccaag

SEQ ID NO: 10 - DNA, 30 bp, Artificial Sequence
  Description of Artificial Sequence Synthetic probe
cggaagatcacaggagtcgaacctgcccgg

SEQ ID NO: 11 - DNA, 30 bp, Artificial Sequence
  Description of Artificial Sequence Synthetic probe
caggggcggagagactcgaactcccaacac

SEQ ID NO: 12 - DNA, 30 bp, Artificial Sequence
  Description of Artificial Sequence Synthetic probe
cactgatatgcgtatttcccgtgcataagg

SEQ ID NO: 13 - DNA, 30 bp, Artificial Sequence
  Description of Artificial Sequence Synthetic probe
catccttatgcaggggaactgctgatcatc

SEQ ID NO: 14 - DNA, 30 bp, Artificial Sequence
  Description of Artificial Sequence Synthetic probe
acgctggataaaactcccctaacagcggtg

SEQ ID NO: 15 - DNA, 30 bp, Artificial Sequence
  Description of Artificial Sequence Synthetic probe
tatagacatatggaggcgtgatgtcttaag

SEQ ID NO: 16 - DNA, 30 bp, Artificial Sequence
  Description of Artificial Sequence Synthetic probe
gactaatgataggtgggtcaggatatcagc

SEQ ID NO: 17 - DNA, 30 bp, Artificial Sequence
  Description of Artificial Sequence Synthetic probe
ccgtggaaactgcgaatgttaaggaaccag

SEQ ID NO: 18 - DNA, 30 bp, Artificial Sequence
  Description of Artificial Sequence Synthetic probe
gctcagatctgcatgtgttgtataacactg

SEQ ID NO: 19 - DNA, 30 bp, Artificial Sequence
  Description of Artificial Sequence Synthetic probe
ttatttatttatgagacaaatgttttaacc

SEQ ID NO: 20 - DNA, 20 bp, Artificial Sequence
  Description of Artificial Sequence Synthetic primer
cgtagctcaggcctcaagac

SEQ ID NO: 21 - DNA, 20 bp, Artificial Sequence
  Description of Artificial Sequence Synthetic primer
gctgcgggctcaatttatag

SEQ ID NO: 22 - protein, 30 aa, Artificial Sequence
  Description of Artificial Sequence Synthetic polypeptide
ARTKQTARKSTGGKAPRKQLATKAARKSAP

SEQ ID NO: 23 - protein, 20 aa, Artificial Sequence
  Description of Artificial Sequence Synthetic peptide
SGRGKGGKGLGKGGAKRHRK

SEQ ID NO: 24 - protein, 20 aa, Artificial Sequence
  Description of Artificial Sequence Synthetic peptide
SGRGKQGGKARAKAKTRSSR

SEQ ID NO: 25 - protein, 30 aa, Artificial Sequence
  Description of Artificial Sequence Synthetic polypeptide
PEPAKSAPAPKKGSKKAVTKAQKKDGKERK